(19) United States
(12) Patent Application Publication
(10) Pub. No.: US 2015/0139498 A1
(43) Pub. Date: May 21, 2015

(54) APPARATUS AND METHOD FOR TIRE SIDEWALL CRACK ANALYSIS

(71) Applicant: Tread Gauge Ptr, LLC, Southbury, CT (US)

(72) Inventors: Dean Rotatori, Naugatuck, CT (US); Arthur Scott McClure, Southbury, CT (US); John Chapdelaine, Southbury, CT (US)

(21) Appl. No.: 14/400,675

(22) PCT Filed: Nov. 5, 2013
(86) PCT No.: PCT/US2013/068431

§ 371 Date: Nov. 12, 2014

Related U.S. Application Data
(63) Continuation-in-part of application No. PCT/US2013/041157, filed on May 15, 2013.
(60) Provisional application No. 61/749,562, filed on Jan. 7, 2013.

(51) Int. Cl. G01M 17/02; G06T 7/00; G06T 7/60; G01B 11/02

(52) U.S. Cl. CPC G01M 17/027; G01B 11/02; G06T 7/0004; G06T 7/602; G06T 2207/10024; G06T 2207/10056; G06T 2207/30164
USPC 382/104

(57) ABSTRACT

An apparatus and method for detecting cracks in automotive tires using an automated optical imaging system that captures an image of the tire, converts the captured image into a grayscale image and next to a binary image, detects discrete shapes from the binary image, bounding each of the discrete shapes by baseline border shapes, and selects a predetermined baseline border shape. The apparatus and method optionally determine if the discrete shape has a tapered end, and if a tapered end is confirmed, calculate a level of jaggedness for the discrete shape, and measure the maximum width of a discrete shape having a predetermined baseline border shape, a tapered end, and a jagged outline, for comparison with industry standards for tire crack widths.

### RELATED APPLICATIONS

This application claims priority to U.S. Application No. 61/749,562, filed Jan. 7, 2013 and PCT Application No. PCT/US2013/041157, filed May 15, 2013.

### BACKGROUND OF THE INVENTION

1. Field of the Invention

The present invention relates to image processing and crack detection in general, and crack detection of tire sidewalls in particular.

2. Description of Related Art

Tires are subjected to one of the harshest environments experienced by any consumer product. They are exposed to acid rain, brake dust, harsh chemicals (gasoline, oil, acid, etc.), and direct sunlight, as well as summer's heat and winter's cold. In general, tires take a serious beating—including constant “stretching” as they roll along the road, while all the time exposed to the harsh environment. Eventually, under constant exposure to this harsh environment, the tire rubber will lose some of its elasticity and allow surface cracks to appear. Almost all tires will exhibit small cracks in the sidewall.

Generally, cracks in the rubber begin to develop over time. They may appear on the surface and inside the tire as well. This cracking can eventually cause, for example, the steel belts in the tread to separate from the rest of the tire, air leakage, and structural instability. Improper maintenance and heat will accelerate the process.

Every tire that is on the road long enough will succumb to age. Generally, tires that are rated for higher mileage have chemical compounds built into the rubber that will slow the aging process, but essentially nothing completely stops the effects of time on rubber, and cracks will develop.

A tire will usually begin to show initial cracking on the outside, right near where the tire and the rim come together. A small amount of cracking is marginally acceptable, but anytime the crack begins to spread up the side of the tire, it is usually time to get the tires inspected.

Vehicles which are parked for extended periods often experience tire sidewall deterioration. Sometimes called tire dry-rot, these sidewalls eventually crack and split. Tires that have cracks within the sidewall are susceptible to leaking or blowing out violently, since the sidewall is weakened.

Tires are black to protect rubber against UV damage. Tire makers use a common type of UV stabilizer generally referred to as a competitive absorber. Competitive absorbers capture and absorb the UV light instead of the tire's rubber. Carbon black, a relatively inexpensive ingredient, can be used as a competitive absorber. The black color however does not lend itself well to visual inspection, and makes it difficult to analyze a crack.

Visually inspecting tires for sidewall cracking or other signs of deterioration becomes more critical as they become older. A reliable, automated inspection could essentially prevent an unscheduled roadside tire change or potential tire or vehicle damage.

The size of the tire cracks, and the difficulty in viewing these cracks on a dark (black) backdrop, makes inspection extremely difficult, inconsistent, and unreliable. There is therefore a need to provide a reliable apparatus and method for gathering visual data of the outside surface of a tire sidewall, enabling the user to identify and analyze sidewall cracks in a reliable, consistent manner.

### SUMMARY OF THE INVENTION

Bearing in mind the problems and deficiencies of the prior art, it is therefore an object of the present invention to provide a reliable, automated tire sidewall crack inspection tool.

It is another object of the present invention to gather visual data of the outside surface of a tire sidewall, enabling a user to identify and analyze sidewall cracks in a reliable, consistent manner.

The above and other objects, which will be apparent to those skilled in the art, are achieved in the present invention which is directed to, in a first aspect a method of measuring a width of a crack in a tire comprising: capturing an image of at least a portion of the tire; converting the captured image into a grayscale image; converting the grayscale image into a binary image; detecting discrete shapes from the binary image; bounding each of the discrete shapes by maximum lateral and longitudinal boundary lines to form baseline border shapes encompassing each of the discrete shapes, and selecting a predetermined baseline border shape for further analysis; for each discrete shape within the baseline border shape, calculating a level of jaggedness for the discrete shape; measuring the maximum width of the discrete shape for those discrete shapes determined to be sufficiently jagged to be a crack; and comparing the measured maximum width of the discrete shape to a predetermined margin for unacceptable widths of the crack.

The method may further include: using a calibration image of known dimension and intensity as a standard to ascertain pixel distance per unit area for the captured image; and comparing the calibration image to the grayscale image to acquire an intensity threshold for the binary image. The binary image may be formed using the intensity threshold.

Color inverting may be performed on the binary image prior to detecting the discrete shapes.

The baseline border shape may comprise a square or rectangle, an ellipse or circle, or other shape tandem combination capable of distinction based upon a calculated distance parameter.

The width of the discrete shape is measured traversing along each pixel, the width measurement comprising: assigning a measurement baseline within the baseline border shape; for each pixel of the measurement baseline, calculating a perpendicular distance from the measurement baseline to a first edge of the discrete shape, and to a second edge of the discrete shape; and obtaining a difference in length between the perpendicular distances calculated at the first discrete shape edge and the second discrete shape edge.

The method may further include, for each discrete shape within the baseline border shape, determining if the discrete shape has a tapered end, and measuring the maximum width of said discrete shape for those discrete shapes determined to be tapered and jagged. The step of determining if each discrete shape in the baseline border shape has a tapered end may include: calculating a running average of width measurements for a set of pixels along the measurement baseline; comparing the running average to individual width measurements for each individual pixel along the measurement baseline; assigning a label to the discrete shape if the individual width measurements decline in value from the running average of width measurements by a predetermined amount.

The step of calculating a level of jaggedness for each of the discrete shape may comprise: analytically traversing a contour of an edge line of the discrete shape; performing a linear interpolation of a segment of pixels defining the contour; assigning a level of jaggedness based on the linear interpolation.

The step of comparing the measured maximum width of the discrete shape to a predetermined margin for unacceptable widths may include comparing the maximum width to tire manufacturer specifications or recommendations for acceptable crack widths.

In a second aspect, the present invention is directed to a method of crack detection in a tire sidewall comprising: capturing an image of at least a portion of the tire sidewall; converting the image to a grayscale image; forming a binary image from the grayscale image based upon an intensity threshold; color inverting the binary image; employing a shape detection algorithm to identify discrete shapes or blobs within the captured image; calculating a bounding baseline shape for each discrete shape identified by the shape detection algorithm; for a predetermined bounding baseline shape, determining if any discrete shape includes a tapered endpoint; for each discrete shape with at least one tapered endpoint, analyzing the discrete shape for jaggedness, and characterizing the discrete shape as a tire sidewall crack if the discrete shape is bounded by a predetermined baseline shape, has at least one tapered endpoint, and is jagged.

The method further includes: calculating the bounding baseline shape by identifying a first set of pixels of the discrete shape furthest away from one another in a lateral direction and forming a lateral segment having a length based on a distance between the first set of pixels, and identifying a second set of pixels furthest away from one another in a longitudinal direction and forming a longitudinal segment having a length based on a distance between the second set of pixels, the longitudinal segment being perpendicular to the lateral segment; and determining if the lateral and longitudinal segments form a square or a rectangle based on a ratio of lengths of the longitudinal segment to the lateral segment.

The method further including: ensuring that at least one endpoint of the discrete shape is within the captured image; performing multiple width calculations for a set of pixels outlining each edge of the discrete shape near the endpoint, for each of the at least one endpoint within the captured image; and determining if the multiple width calculations leading towards the at least one endpoint indicate a continuing decrease in width forming a taper.

In a third aspect, the present invention is directed to a method of determining crack condition on a sidewall of a tire comprising: capturing an image of at least a portion of a sidewall of the tire; converting the captured image into a grayscale image; converting the grayscale image into a binary image; detecting discrete shapes from the binary image; selecting a discrete shape from the binary image; determining if the selected discrete shape is a tire sidewall crack; if the selected discrete shape is determined to be a tire sidewall crack, measuring maximum width of the selected discrete shape; comparing the measured maximum width of the tire sidewall crack to a predetermined margin for unacceptable widths; and determining the tire sidewall crack condition based on the degree of crack width.

In a fourth aspect, the present invention is directed to an apparatus for tire sidewall crack inspection comprising: a scope providing image magnification and lighting for capturing an image of at least a portion of the tire sidewall; a microprocessor based system for analyzing the captured image, the microprocessor based system in electrical communication with the scope and tangibly embodying a program of instructions performing the process steps of: capturing an image of at least a portion of the tire; converting the captured image into a grayscale image; converting the grayscale image into a binary image; detecting discrete shapes from the binary image; bounding each of the discrete shapes by maximum lateral and longitudinal boundary lines to form baseline border shapes encompassing each of the discrete shapes, and selecting a predetermined baseline border shape for further analysis; for each discrete shape within the baseline border shape, calculating a level of jaggedness for the discrete shape; measuring the maximum width of the discrete shape for those discrete shapes determined to be sufficiently jagged to be a crack; and comparing the measured maximum width of the discrete shape to a predetermined margin for unacceptable widths of the crack. The largest visible crack on the tire sidewall tire may be used to determine the sidewall crack condition, and the sidewall crack condition may be determined by placing the tire sidewall crack in a category of acceptability selected from different categories of acceptability.

The program of instructions of said microprocessor based system may further perform the process steps of, for each discrete shape within the baseline border shape, determining if the discrete shape has a tapered end, and measuring the maximum width of said discrete shape for those discrete shapes determined to be tapered and jagged.

The scope includes a tire mating end having activation switches electrically connected in series to initiate image capture when the switches are simultaneously activated.

The lighting may include at least one light emitting diode, a laser diode, or an incandescent light source within the scope or connected to the scope by optical waveguide.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts an embodiment of the inspection scope of the present invention;

FIG. 2 depicts a tire sidewall image capture using the software platform of the present invention in concert with the lighting, magnification, and photographic attributes of the inspection scope of FIG. 1;

FIG. 3 depicts the captured image of FIG. 2 converted to grayscale using a grayscale algorithm;

FIG. 4 depicts the binarization of the captured grayscale image of FIG. 3;

FIG. 5 depicts the conversion of the binarized image of FIG. 4, inverting the white and black pixels;

FIG. 6 depicts an image showing two globules or blobs bounded by discrete shapes;

FIG. 7 depicts an exemplary crack bounded by a discrete shape in the form of a rectangle having a measurement baseline shown as a centerline;

FIG. 8 depicts analysis of an exemplary crack to determine end taper;

FIGS. 9A and 9B depict analysis of an exemplary tire text and crack, respectively, to determine jaggedness;

FIGS. 10A and 10B depict the general method steps of the algorithms performing the present invention; and

FIG. 11 shows an exemplary handheld tire sidewall crack analyzer employing the method and system of the present invention.

### DESCRIPTION OF THE PREFERRED EMBODIMENT(S)

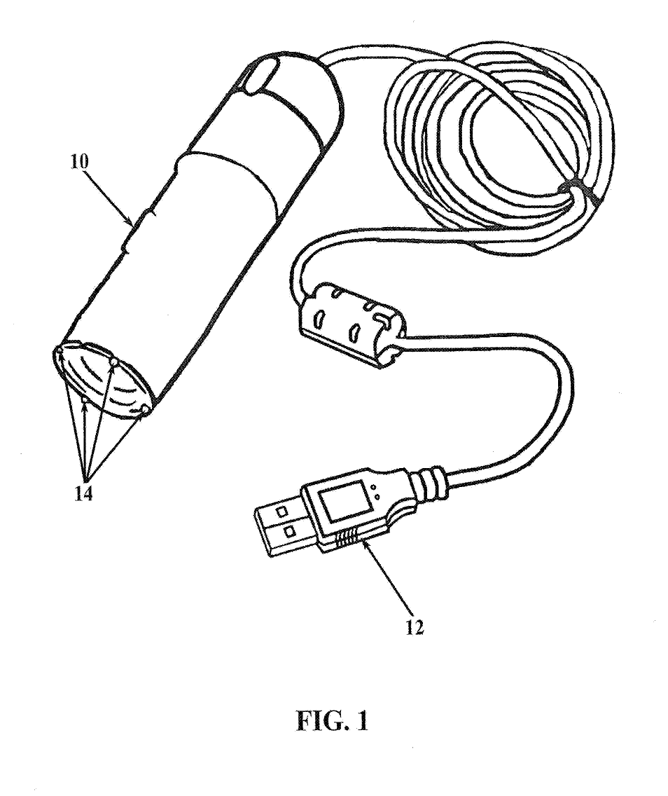

In describing the embodiments of the present invention, reference will be made herein to FIGS. 1-11 of the drawings in which like numerals refer to like features of the invention.

In an embodiment, the present invention provides an apparatus and method for detecting cracks in automotive tires, and particularly, detecting cracks in the sidewalls of tires using an automated optical imaging system. In this manner, automated detection and identification of cracks in tire sidewalls can be achieved for early correction and/or replacement.

In one embodiment, a computer based application interfaces with an illuminated inspection scope to capture high-magnification images of a tire sidewall in order to provide a digital image for analysis of cracks in the sidewall. The method makes possible a consistent and reliable visual detection and assessment of tire sidewall cracks that may pose a serious risk if left unchecked.

The illuminated inspection scope may be a video source in the manner of a microscope, high resolution webcam, or other visual image camera. Digital image processing is performed on the resultant image from the inspection scope to identify sidewall cracks and measure physical characteristics, such as distance in the form of crack width, although other physical attributes may be gathered and analyzed, and the invention is not limited to an analysis of a single physical attribute. The digital image processing is performed to a specific set of algorithms uniquely tailored to tire sidewall degradation analysis and crack detection. Crack detection methodology relies in part upon the nature of cracks being elongated with tapered ends or edges, and jagged in a piecewise linear fashion. Resolving an elongated, tapered end, jagged attribute in a captured image from an otherwise piecewise nonlinear attribute in the image allows the detection system to differentiate between sidewall cracks and raised symbols and lettering commonly placed on tires.

Video capture, image processing, and crack detection, may be performed using an open source framework. One such framework which may be utilized is the AForge.NET™ framework, which is an open source C# framework designed for developers and researchers in the fields of computer vision and artificial intelligence—including applications for image processing, neural networks, genetic algorithms, fuzzy logic, machine learning, robotics, among other applications. However, the present invention is not limited to any particular framework, and other application software platforms may be utilized.

FIG. 1 depicts an embodiment of the inspection scope of the present invention. The scope 10 includes a USB electrical connector 12 for communication with a computer or other processing and/or data capture device. Scope 10 may include an internal video camera with optics for magnification, an illumination source, such as light emitting diodes, or other light sources of predetermined wavelength(s) to enhance image capture upon reflection. The end portion of scope 10 where light is emitted may include a plurality of switches 14 to signal the connecting device to capture the image. It is possible for the illumination source and magnification optics to be placed in a device that communicates with the scope via optical waveguides, and as such, scope 10 may be a lighter, less complex, and less fragile handheld instrument.

Switches 14 are configured to be implemented so that scope 10 is in proper contact with the tire when the switches are compressed. Switch compress initiates or triggers image capture. This prevents accidental image capture prior to contact with a tire. Accidental image capture would adversely affect crack detection and measurement accuracy. The distance between scope 10 and the tire sidewall would greatly vary from one captured image to the next if triggering the captured image was not dependent upon a complete activation of switches on the circumference of the scope's contacting edge.

In one embodiment, four switches 14 are arranged on the end of scope 10. Although the present invention is not specifically dedicated to four switches, any number of a plurality of switches may be used. Switches 14 electrically communicate in a series wired arrangement circumferentially about the scope leading contacting edge. This arrangement allows the image to be captured only when scope 10 is squarely against the tire, and ensures equidistance focal lengths for each image. In a series wired configuration, all switches 14 must be activated upon compression in order to activate image capture.

Concurrent with the implementation of scope 10 and the subsequent capture of an image is the implementation of a set of algorithms to determine the character of identifiable shapes on the image, and assess whether those shapes are indeed cracks.

The set of algorithms includes an auto calibration routine. The calibration algorithm is performed on a target of known dimensions. Due to the ultimate determination of a black target disposed on a black background, the calibration algorithm is performed to assist in adjusting the threshold value for optimal contrast. This is necessary for an objective demarcation between cracks and raised lettering and symbols on a tire's sidewall. For additional contrast, the tire sidewall surface may be coated or painted with a contrasting color composition that does not interfere with the detection of the black (crack) target, for example, using a light colored tire crayon. Another option is to apply a composition so that it leaves a contrasting color only within the crack itself, to contrast with the black tire sidewall.

A calibration algorithm routine may be used to set a threshold level for a predetermined minimum value to enhance image contrast. Once the minimum value is set, an iterative calibration loop is initiated to enhance resolution. Normal image processing is performed on a selected calibration image using a shape recognition algorithm. For example, in one embodiment, a calibration “square” image of known dimensions and measurable image intensity is captured by the image scope and analyzed by the calibration subroutine. The shape recognition algorithm is used to recognize the calibration “square.” The shape recognition algorithm may be an “off-the-shelf” packaged software routine that is capable of differentiating between shapes within a certain level of resolution. For exemplary purposes, the shape used for calibration is a 3 mm×3 mm square (the “calibration square”). Other shapes and sizes may be employed with the restriction that the calibration shape is of a resolution capable of discerning its pixel/unit length value.

From the known dimensions of the calibration image, a value for the number of pixels per unit length is determined by dividing the width of the calibration image, such as an edge segment of a calibration square in pixels by the known width of the square in unit length to obtain, for example, a pixel per unit of length measure. To enhance accuracy in measurement, the calibration algorithm then compares the difference between the newly measured pixel/unit length value (e.g., pixel/mm) with a last previously known pixel/unit length value. If the difference between these two values is less than or equal to a predetermined set value, such as 1 millimeter for example, a counter is incremented; otherwise, the counter is cleared. The calibration iteration loop is exited if the counter reaches a preset level, thereby indicating that an adequate threshold has been found and the system is now calibrated. Otherwise, the threshold level is incremented, and the calibration loop is performed again. Once the calibration loop settles on a threshold level, a confirmation dialog is displayed to the user, allowing the user to save the system calibration.

The calibration algorithm may be determined in a standard, non-dynamic mode, as well as in a dynamic, in-situ mode. Scope 10 with switches for image activation assist in the calibration dynamic mode by assuring a uniform and known distance to the tire (and image).

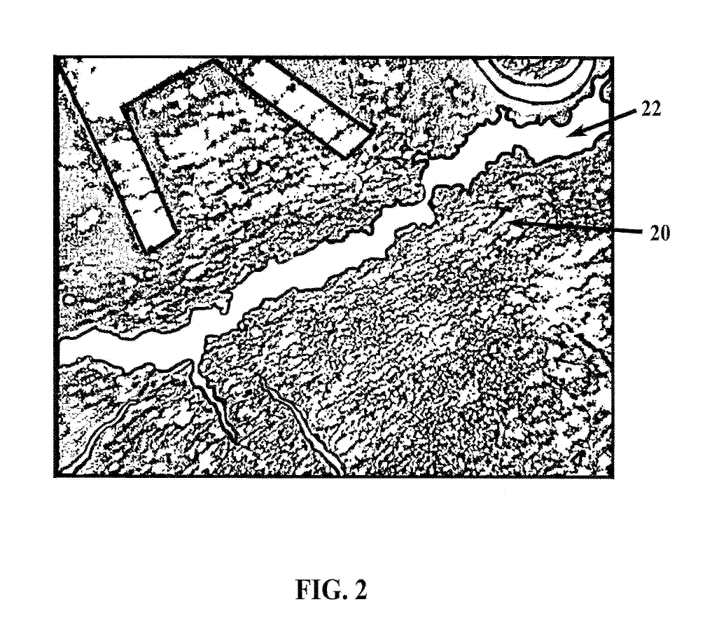

In order for the system to detect tire cracks, it must capture the images taken of the cracks, and perform digital analysis on the captured images. Using a software platform such as the AForge.NET framework for video capture and image acquisition, the present invention uses scope 10 to secure digitally the image. FIG. 2 depicts a tire sidewall image capture using the AForge.NET software platform in concert with the lighting, magnification, and photographic attributes of scope 10. For exemplary purposes, scope 10 used to take this image is a Veho™ Discovery VMS-001 USB microscope; however, the present invention is limited only in the degree of magnification and resolution provided by the scope, and not any particular scope model type or manufacturer. A portion of tire sidewall 20 in FIG. 2 is depicted showing crack 22 traversing there through. At this juncture, it is uncertain if this image is indeed a crack, and if analytically determined to be a crack, the full extent of the crack width must be determined. Although the image has been digitally captured in photo, its identification and characteristics are unknown and require further analysis for assessment.

Digital image processing is required to ascertain the dark colored crack from the dark tire sidewall background. For each video frame or still image taken of the tire sidewall digital processing must be performed.

The system algorithm next converts the captured color digital image to grayscale using a grayscaling filtering routine. A grayscale digital image is an image in which the value of each pixel is a single sample, that is, it carries only intensity information. Images of this sort, also known as black-and-white, are composed exclusively of shades of gray, varying from black at the weakest intensity to white at the strongest. In a system for such purposes, an image of the object is generally acquired using an image capture apparatus and the image is input to an image processing system as an analog signal comprising Y values, representing the lightness for each pixel. The analog Y values input are generally converted into digital Y values, which are then stored in a storage buffer. The image processing system displays the image on a display unit based upon the stored information.

To convert any color to a grayscale representation of its luminance, one must obtain the values of its red, green, and blue (RGB) primaries in linear intensity encoding, such as by gamma expansion. For standard RGB color space, the gamma expansion is defined as:

$${C}_{linear} = \{ \begin{matrix}\frac{{C}_{srgb}}{12.92} , & {C}_{srgb} \leq 0.04045 \\ {( \frac{{C}_{srgb} + 0.055}{1.055} )}^{2.4} , & {C}_{srgb} > 0.04045\end{matrix}$$

where C_{srgb} is any of the three gamma-compressed standard RGB primaries in
range [0,1]; and
Cₗᵢₙₑₐᵣ is the corresponding linear-intensity value (also in range [0,1]).

The values for C_{srgb} and Cₗᵢₙₑₐᵣ will vary depending upon the application. The values depicted are standard grayscale filtering values. Other values may be considered more appropriate for the present application; however, the present invention is not limited to any single set of constants, and other empirically derived values may be better suited for particular applications.

Luminance is then calculated as a weighted sum of the three linear-intensity values. Linear luminance typically needs to be gamma compressed to get back to a conventional grayscale representation. To encode grayscale intensity in RGB, each of the three primaries may be set to equal the calculated luminance. For standard RGB, the appropriate gamma compression may be generally represented by:

$${C}_{srgb} = \{ \begin{matrix}12.92 {C}_{linear} , & {C}_{linear} \leq 0.0031308 \\ 1.055 {C}_{linear}^{1 / 2.4} - 0.055 , & {C}_{linear} > 0.0031308\end{matrix} .$$

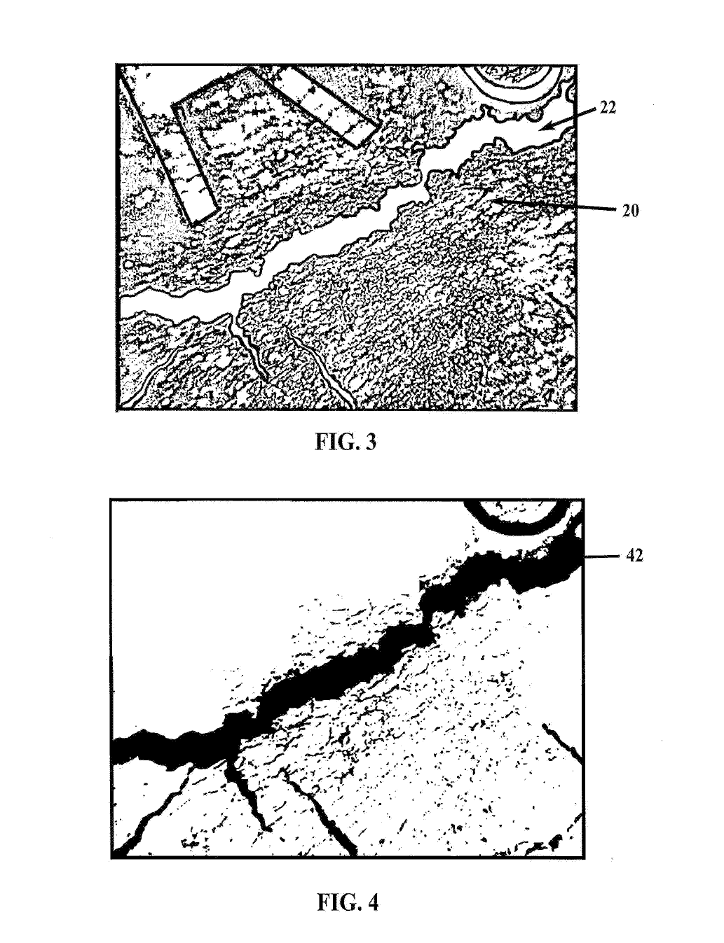

The grayscaling algorithm of the present invention may specify red, green, blue conversion coefficients, such as those defined above, for use in color imaging conversion to grayscale. The grayscale filter is applied to the bitmap image. FIG. 3 depicts the captured image of FIG. 2 converted to grayscale using a grayscaling algorithm. Grayscale filtering reduces the color depth of the image and improves the image processing speed.

Once the image is in grayscale, using the calibration square and threshold filtering, a true black and white construct image can be created. Threshold filtering performs image binarization using a predetermined specified threshold value. The threshold value represents the minimum level of binarization to discern the black calibration square from the gray components. Binarization creates a binary image from the captured image by replacing all values above the globally determined threshold with a digital 1 and others with a digital 0. Thus, above a certain threshold level, the image pixels will be assigned one display intensity value (e.g., white), and below the same threshold level, the image pixels will be designated the other display intensity value (e.g., black).

Binarization plays the important role in document processing since its performance is quite critically the degree of success in subsequent character segmentation and recognition. In one embodiment, the binarization threshold for intensity is determined from a comparison to the calibration square. Typical binarization intensity thresholds will be in the range of 30% to 70% of the calibration image intensity. Once determined, the binarization process is performed on all globules within rectangles. After binarization, cracks in the tire sidewall are converted to black splotches or globules, otherwise referred to as “blobs”, while the remaining pixels are assigned white. The threshold level is adjustable to selectively filter out surface features and other anomalies, or conversely, to capture these objects. For tire sidewall crack analysis, the threshold level is adjusted to filter out most normal surface features, such as raised numbers and symbols formed on the tire.

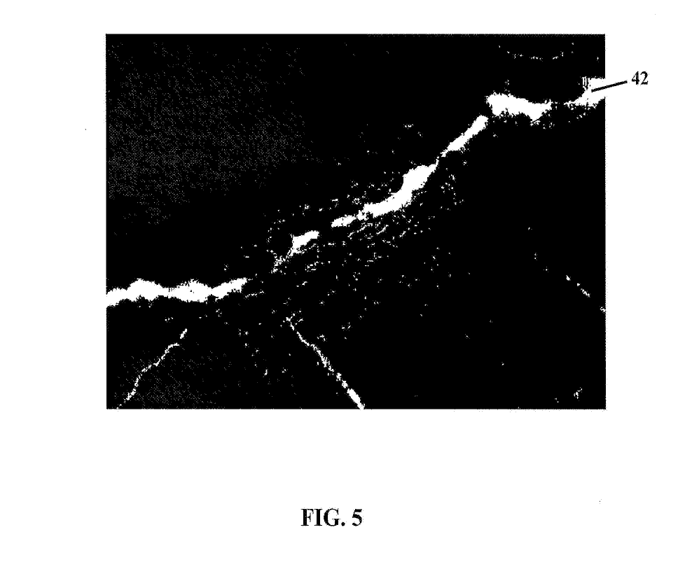

When automatically calibrating the captured image pixel dimensions, the threshold level is adjusted so as to not filter out the surface features. FIG. 4 depicts the binarization of the captured grayscale image of FIG. 3. The binarization of crack 22 of FIG. 2, is depicted as “blob” line 42.

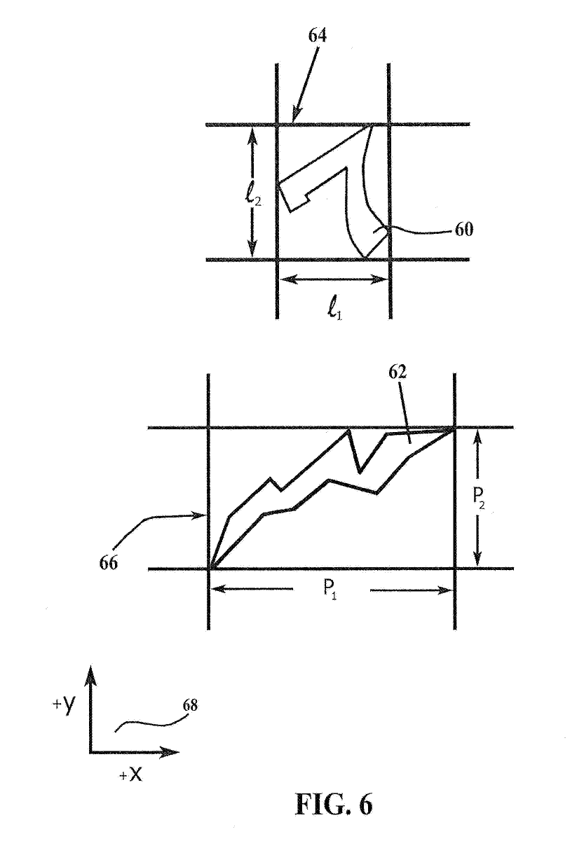

In one embodiment, the system algorithm next performs a color inversion of the binarization image. The binarization of the captured image is converted such that each white pixel is transformed to a black pixel, and each black pixel is transformed to a white pixel. FIG. 5 depicts the conversion of the binarized image of FIG. 4, inverting the white and black pixels. The inversion allows for a visual inspection of the blob, and lends itself to further analysis. Each pixel is labeled based on its intensity value. This assessment is done pixel-by-pixel, row-by-row. The splotches or globules (blobs) are groups of pixels that share the same assigned label. Once all the pixels are labeled, the properties of the splotches (blobs), such as edges, width, height, area, etc., are acquired for each blob in the captured image.

In this manner, the splotches or blobs that are present in the image are detected and analyzed. In one methodology, using the previously determined calibrated pixels-per-unit length, e.g., pixel/mm, the maximum width of each blob is analytically determined.

The methodology for implementing the analytical determination of the maximum width of a discrete shape such as a blob includes first bounding the white blob image by a baseline border shape using lateral and longitudinal boundary lines. These lines would generally form either a square or a rectangle depending upon the dimensions of the longest length and width of the white image as obtained from the “binarized” image pixel assignment. The “width” measurement is made perpendicular to the length measurement. In one embodiment, the white pixels furthest away from one another in a lateral direction are assigned a first length, and the white pixels furthest away from one another in a longitudinal direction are assigned a second length, the longitudinal direction being perpendicular to the lateral direction. The lengths are obtained from the calibration factor (pixels/unit length) determined previously, by dividing the number of pixels establishing a given length with the calibration factor. The calculated first and second lengths form a bounding shape for the splotch or globule (“blob”) identified by the white pixels. Depending upon the lengths determined, the initial bounding shape will be either a square or a rectangle. If the lengths are relatively equal (within predetermined limits) the initial bounding shape is considered a square. For example, depending upon the resolution desired, if the shorter length is 10% to 50% of the longer length, the initial bounding shape may be considered a rectangle. The differentiation between rectangle and square may be assigned when the shorter length is on the order of 25% of the longer length.

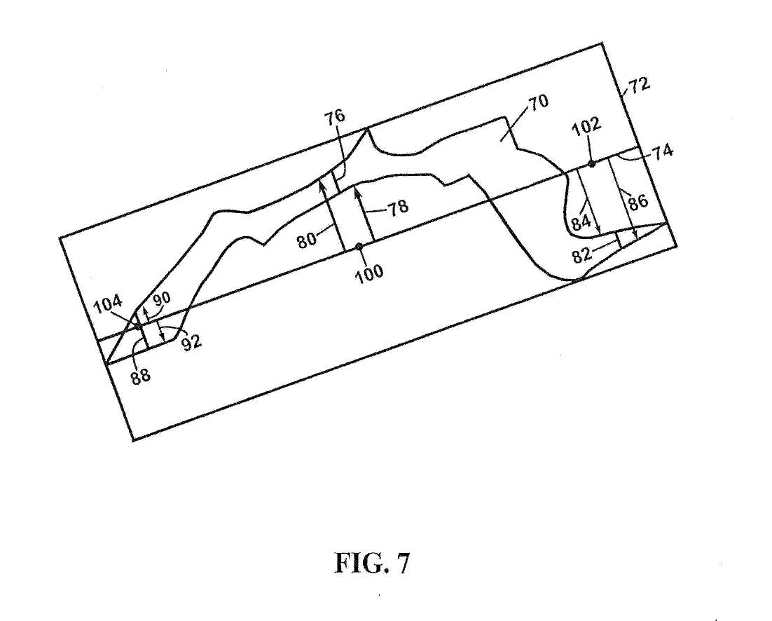

If the first and second lengths are not equal by the predetermined amount, the initial bounding shape is considered a rectangle, and the shorter of the two lengths is considered the width. FIG. 6 depicts an image having two globules or blobs 60, 62. Blob 60 is determined based on the measurement of the farthest distance in one direction, for example along the x-axis, and the farthest distance in a perpendicular direction, such as the y-axis. A relative coordinate marker 68 is depicted in the lower corner of the figure. Blob 60 is shown with two measured lengths, l₁ in the x-direction and l₂ in the y-direction. For blob 60, the smaller length, l₁ is assigned the “width”, and the larger length l₂ is assigned the length. For this example, the two lengths are within a predetermined amount of one another, that is, l₁ is greater than 25% of l₂. Therefore the blob 60 is analytically determined to be a square 64, and blob 60 (a raised number “7” as depicted in FIG. 6) is omitted from further analysis.

In a similar fashion, blob 62 is determined based on the measurement of the farthest distance between pixels of a predetermined intensity in one direction (e.g., along the x-axis) and the farthest distance between pixels of the predetermined intensity in a perpendicular direction (e.g., along the y-axis). Blob 62 is shown with two measured lengths, p₁ in the x-direction and p₂ in the y-direction. For blob 62, the smaller length, p₂ is assigned the “width”, and the larger length p₁ is assigned the length. For this example, the two lengths are not within a predetermined amount of one another. Therefore the blob 62 is analytically determined to be a rectangle 66, which warrants further analytical inspection.

Although rectangles and squares are used as bounding shapes for discerning cracks in a tire sidewall, other shapes are not precluded, and the invention is not limited to any specific bounding shape. For example, an elliptical structure may be used with its longitudinal length associated with a crack length, and its lateral length associated with a crack width, while if the major and minor axes are within a predetermined value of one another, the bounding shape would be considered a circular structure that may indicate a globule that does not warrant further analysis as a crack.

Since the formation of cracks and their ultimate propagation result in narrow, elongated structures, there is a high probability that distinguishing the binarization image as either a rectangle or a square will isolate structures that are cracks from those structures that represent raised symbols or lettering on the tire sidewall. At this juncture, analytically defined rectangular (or elliptical) structures continue to be analyzed, while square (or circular structures) are omitted from further calculation.

For each rectangle boundary shape defined, the contour of the globule or blob inside the rectangle is analytically inspected to determine if the globule or blob shape is indicative of a crack. If at least one end of the blob is within the image, the end within the image is analytically inspected for tapering. If there is no endpoint to the blob, the image may be discarded, or an adjacent image may be combined with the current image to follow the blob shape to an endpoint. Once an endpoint is determined, a “tapering” algorithm is employed. In this manner, cracks are distinguished in part by those images having elongated shapes with at least one tapered endpoint.

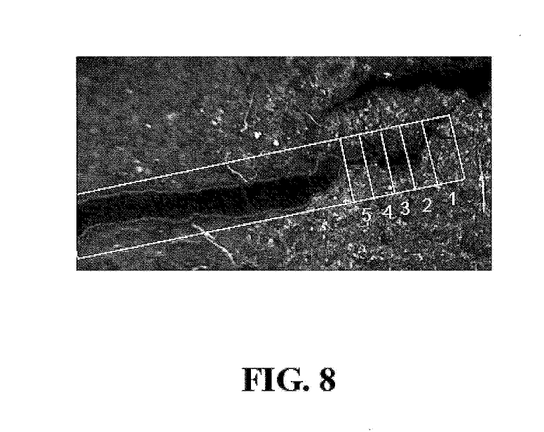

The bounding baseline rectangular shape defining and bounding the current splotch or blob under inspection is analytically given a measurement baseline that traverses its length. For each pixel along this measurement baseline, the distance in either direction perpendicular to the measurement baseline is obtained to the outermost pixels of the blob image outline. In one embodiment, the measurement baseline is a centerline of the rectangle. FIG. 7 depicts an exemplary image of a discrete shape (blob) 70 bounded by a baseline shape in the form of a rectangle 72 with measurement baseline 74 shown as a centerline. Using measurement baseline 74, a width measurement 76 of blob 70 at each pixel point incremented along the centerline is calculated and recorded. There may be two distinct calculations to consider depending upon the location of the blob about the centerline. If the centerline is considered a starting point or zero point for width calculation purposes, the calculations will differ depending upon where the blob is in relation to the centerline. For a given pixel on the centerline, if the blob edges' closest, innermost pixel to, and farthest, outermost pixel from, the centerline pixel are on the same side of the centerline, the width calculation is determined from the difference in length from each edge pixel to the centerline; and 2) for a given pixel on the centerline, where the blob encompasses the centerline pixel, and the blob edges are on opposite sides of the centerline, the width calculation is determined from the sum of the lengths from each edge pixel to the centerline.

Referring to FIG. 7, for instances where the blob edges analyzed are both above centerline 74, such as at pixel 100, width measurement 76 is calculated by determining the difference between distance 78, measured from pixel 100 to the innermost, closest edge of the blob, and distance 80, measured from pixel 100 to the outermost, farthest edge of the blob. For instances where a portion of the blob is below centerline 74, such as at pixel 102, width measurement 82 is calculated by determining the difference between distance 84, measured from pixel 102 to the innermost edge of the blob, and distance 86, measured from pixel 102 to the outermost edge of the blob.

For instances where the blob straddles centerline 74, such as at pixel 104, width measurement 88 is calculated by adding the distance 90 from centerline 74 at pixel 104 to the outermost edge of the blob in one direction, to the distance 92 from the centerline at pixel 104 to the outermost edge of the blob in the opposite direction. It is noted that although an “addition” and “subtraction” of distances are proposed, the actual operations may vary depending upon the reference frame of the centerline. If the centerline is considered a zero point for measurement, then points below the centerline would be calculated as negative lengths, and points above the centerline would be calculated as positive lengths. In the case of having both bounding edges of the blob being above the centerline, the length values calculated would be positive, and the difference between them (width length) is merely a result of subtraction of the two lengths. If the bounding edges of the blob are both below the zero point centerline, the length values calculated would be “negative” and the difference between them (width length) would be the subtraction of the negative values of these lengths. If the bounding edges of the blob straddle the centerline, one length value calculated would be positive and the other length value negative. A subtraction of the negative value from the positive value would result in the addition of the two absolute values as the width length. Consequently, the operation to determine width length (addition or subtraction), as well as an assignment of an absolute value of a given length, is dependent upon the reference used, and the present invention is not limited to any particular reference frame or starting point.

From the width values recorded, a running average is calculated based on a predetermined width segment, incrementally advanced by a single pixel along the measurement baseline for each running average calculation. The predetermined width segment may be any length; however, in one embodiment a ten (10) pixel width segment was found to be sufficient for calculation purposes. The individual width measurements are compared with the running average to ascertain a steadily decreasing width measurement, which would signify a tapering of the blob endpoint.

If the end of a crack is detected within the captured image, taper analysis is performed on the blob to assist with the discrimination between cracks and surface features. An end is classified as such if there is at least one pixel between the blob and its nearest image edge(s). In the crack shape analysis the constraints of the pixels making up the blob are used to allow a bounding box to be virtually drawn around the crack. If the blob is rectangular in shape with one dimension of the rectangle having a length of a minimum factor greater than the width, then the blob is initially classified as a crack and further analysis ensues.

The end taper analysis is performed by starting at one end of the blob and measuring the width of the blob over a percentage of the blob (currently 25% of the length is analyzed on either present end). The width is measured for each pixel in length along the analyzed section. Since the tire cracks typically have jagged edges (nonlinear) a weighted average is used to compare the width over the analyzed section. The analyzed section is broken down into a series of segments (currently 5 segments, each ⅕ of the analyzed section). The width of each pixel width within the segment is averaged and the resulting 5 segment average widths are used to determine if the end tapers. If the average segment width from one segment to the next (starting with the end segment) is greater by a minimum factor (currently 10%) for a minimum of three of the segments then the blob is determined to have sufficient end taper to classify it as a crack.

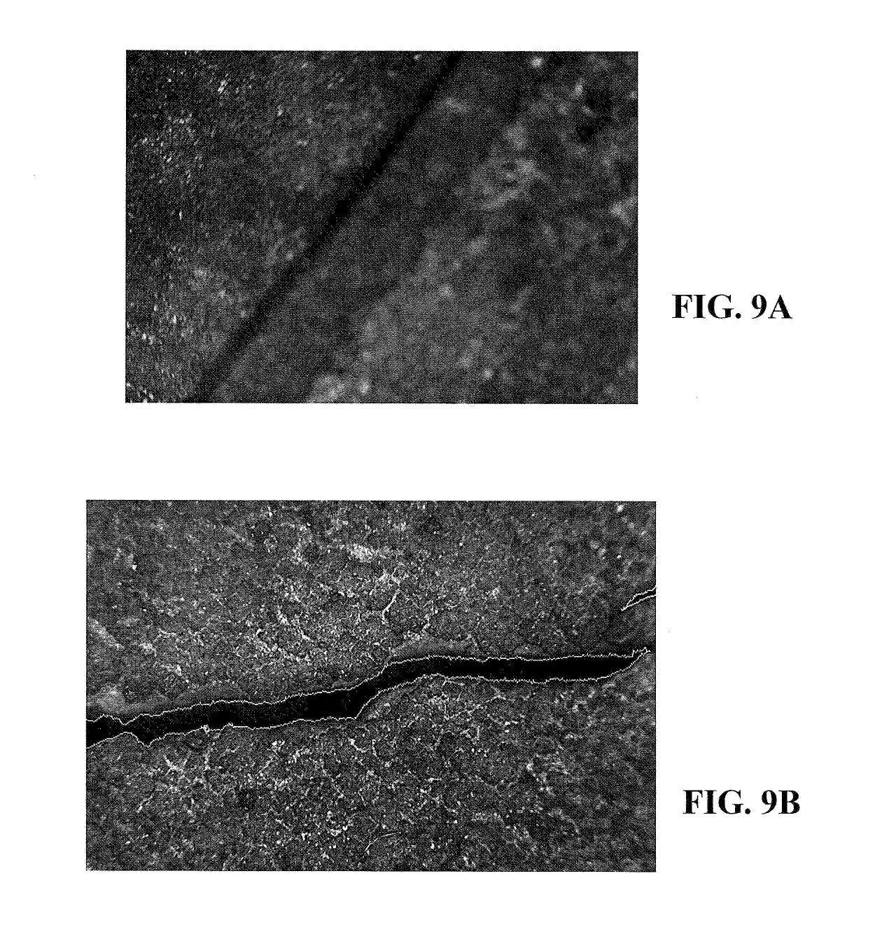

The image shown in FIG. 8 demonstrates this where from segment 1 to 2 and 2 to 3 there is greater than a 10% increase in average width, but from 3 to 4 there is less than a 10% increase in average width and in 4 to 5 there a decrease in average width. This blob would be considered to have sufficient end taper as with 3 of the 5 segments greater than a 10% increase in average width is measured.

The tapering algorithm that may be employed in the present invention determines the presence of a steadily decreasing width measurement of the blob being measured, as described above. The algorithm to determine if the blob being analyzed has a tapered end may include: 1) calculating a running average of width measurements for a set of pixels along the measurement baseline; 2) comparing the running average to individual width measurements for each individual pixel along the measurement baseline; and 3) assigning a label to the discrete shape if the individual width measurements declines in value from the running average of width measurements by a predetermined amount. A ten percent (10%) drop in width may be used to analytically define a tapering. If such a predetermined drop in width is measured, then the blob is determined to have a tapered end. If the blob is determined to have a tapered end, there is a high likelihood that the blob is indeed a crack worthy of further inspection. If the endpoint(s) of the blob is free from taper based on the mathematical framework for determining blob narrowing, the blob is not considered a crack, and removed from further analysis.

Next, assuming the blob has at least one end that is tapered, it is then checked for jaggedness, since blobs that have a non-linear shape, smooth edges, and/or which lack any significant tapering at their ends are dismissed as markings or anomalies on the tire surface, such as raised tire sidewall molded text (numbering and lettering). Consequently, the contour of the blob is analyzed for piecewise linearity that would indicate jagged edges.

To differentiate between cracks and other tire surface features, the edges of the blobs are analyzed for their jaggedness. Unlike a cut, which would have relatively smooth edges, tire cracks form with very uneven edges. To classify the jaggedness of a blob, the perpendicular distance from the long direction centerline to the edge of the blob is measured from one end to the other of the bounding rectangle. Linear regression is used to determine the linearity of the long edge or edges of the blob. (If one edge of the crack is predominantly against the edge of the image it is not used, as it would falsely appear to be linear). Linear regression is calculated by:

m=nSxy−SxSy/(nSxx−SxSx)

The regression ratio can vary from 0 to 1, with 1 indicating perfect linearity. If the regression ratio is lower than a threshold (currently 0.5) then the blob edge is considered to be jagged enough to classify it as a crack, rather than surface feature.

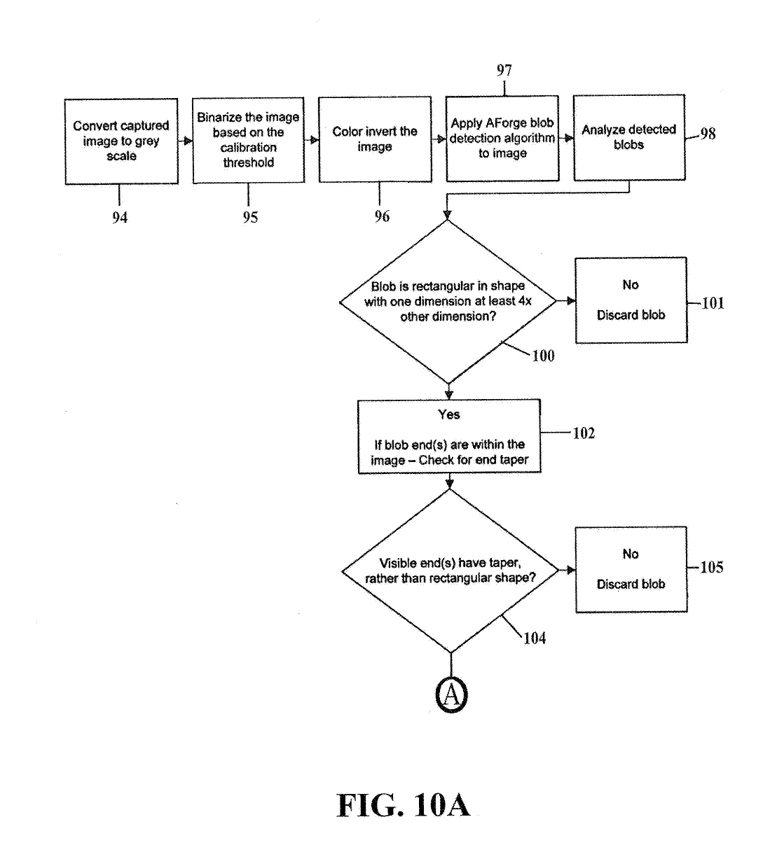

The images in FIGS. 9A and 9B shows molded tire text and a surface crack. For the molded text, FIG. 9A, the center and right sections would be filtered out by the threshold. The dark line on the left edge would not be filtered out by the threshold, so analysis would be performed on it. Linear regression analysis results in a 0.81 linear regression ratio for the top edge and 0.78 for the bottom edge, so being over the rejection limit, this molded text would be classified as not being a crack. On the other hand, the surface crack shown in FIG. 9B yields a 0.32 linear regression ratio for the top edge and 0.27 for the bottom edge, resulting in the classification of being a crack.

The algorithm to determine if a blob being analyzed has a jagged edge as described above may include using the defined pixel locations that identify the binarized blob image, traversing the contour of the blob outline, and performing a linear interpolation of piecewise pixel segments. If piecewise linear segments cannot be determined from the contour, the surface is considered smooth and most likely not of a crack. Piecewise linearity is demonstrative of a level of jaggedness in a crack. The specific level of linearity to be employed to differentiate smooth from jagged (and therefore crack) edges may be determined without undue experimentation.

If the end of a crack is not visible or otherwise not available for analysis, the blob or shape may be determined to be a crack by measurement of the level of jaggedness alone, without determining if it has a tapered end.

From the above-identified width measurements, the maximum width of each discrete shape or blob is calculated and checked against predetermined values for rejection and marginal size. Thresholds for suspect crack widths, typically in fractional millimeters, are compared to manufacturer specifications to determine if the tire passes inspection, is suspect, or fails. The result is displayed to the user.

In addition to individual crack assessment, an assessment of crack density can be calculated from the analytical data provided, and compared to manufacturer specifications. This can be performed by measuring the spacing between the blobs in the captured image to calculate a blob per unit area for the image.

Furthermore, to accommodate tire manufacturers that specify the criticality of the depth of a crack, once a blob is determined to be a crack, the crack depth is measured by examining an unprocessed captured image. A measurement of the blurring is performed by comparing the intensity of the inner portion of the crack to the intensity at the edges of the crack. Steps of focal distance are then interpolated as depth. A calibration technique is employed to generate a scale for focal distance versus depth.

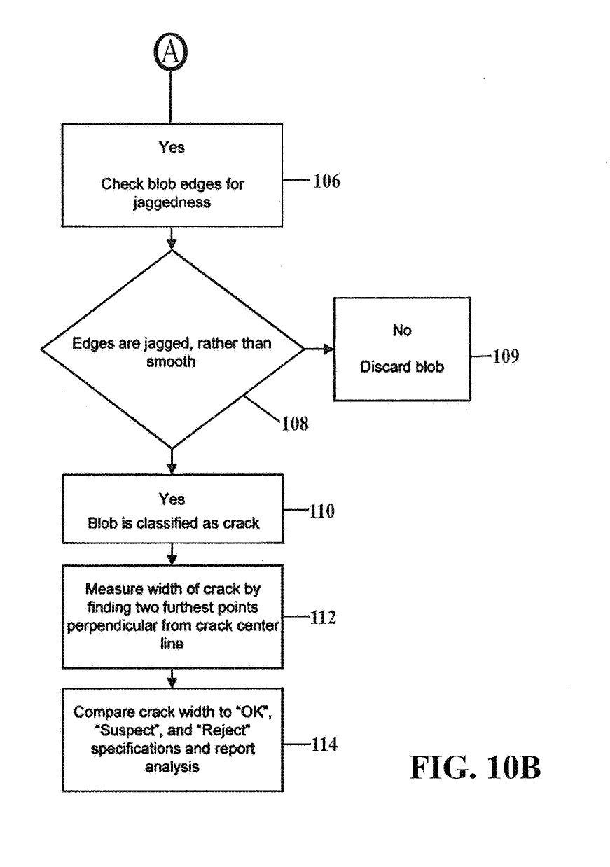

FIGS. 10A and 10B depict the general method steps of the algorithms performing the present invention. Once the captured image is converted to grayscale 94, the image is binarized based upon a calibration threshold 95. The image may then be color inverted 96. A shape detection algorithm 97 is employed to identify blobs in the image. The individual blobs are then analyzed 98 and particular bounding baseline shapes are assigned to each blob 100, for example square and rectangle, or elliptical and circular, to name a few. As an illustrative example, if rectangles and squares are the bounding shapes used for analysis, a blob is outlined as rectangular if one dimension is at least four times its perpendicular dimension. If the blob is not deemed rectangular, no further analysis of the blob is required 101. If, however, the blob is determined to be a rectangle, the blob is next confirmed to ensure that at least one end is within the captured image 102, and if at least one end is within the captured image, the blob end is analyzed for tapering. Upon analyzing the blob end for tapering, if tapering is found 104 the blob edges are analyzed for jaggedness 106; else, no further analysis of the blob is required 105.

The blob edges are analyzed for jaggedness 108. If they are deemed not jagged, no further analysis of the blob is required 109. If the edges are jagged (and tapered) the blob is characterized as a crack 110. Alternatively, if the image of the crack end is not being used, the blob may be characterized as a crack if the edges are determined to be jagged, without tapering analysis. The maximum width of the blob is calculated 112, and the width is compared to manufacturer specifications for acceptable, suspect, or rejected tires 114.

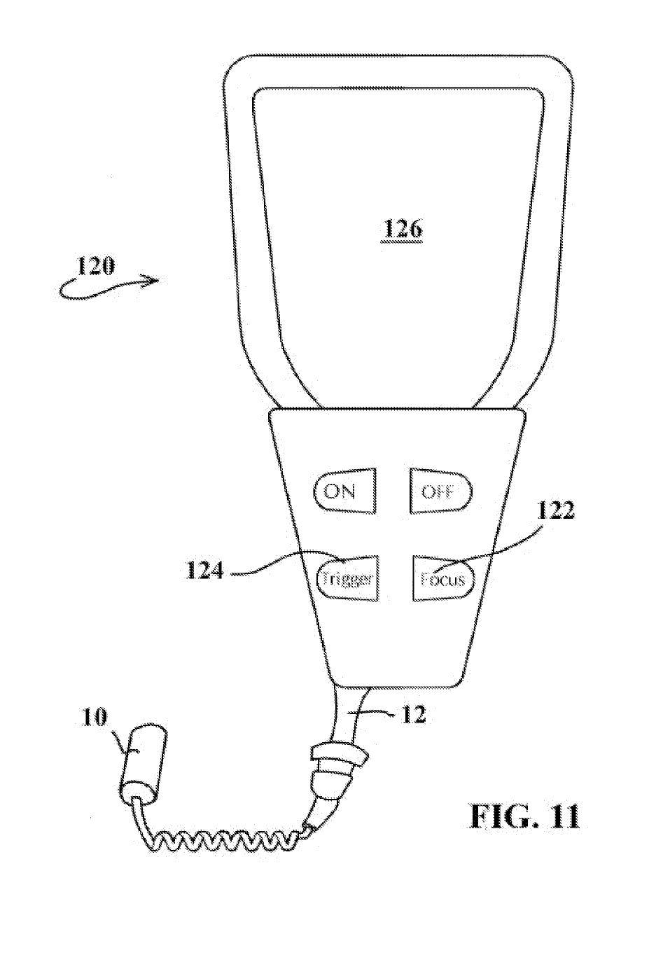

The apparatus for measuring width of a crack and inspecting tire sidewalls may be provided in a handheld unit that incorporates the systems, methods and features described above. An example is shown in FIG. 11 in which the apparatus 120 housing contains the computer or other processing and/or data capture device. A microprocessor therein stores and executes the program of instructions performing the aforedescribed process steps. Connector 12 linked by electrical cable or optical waveguide 11 connects with scope 10 as previously described, and plugs into housing 120 for communication with the microprocessor and remainder of the system. Focus switch 122 may be operated by the user's fingers to focus the image received from the scope 10. Finger operated trigger switch 124 may initiate image capture in conjunction with or independent of triggers 14. Screen 126 displays the images of the suspect crack to be analyzed and categorized.

The present invention may be embodied as a system, method or computer program product. The present invention, other than the scope and image screen, may take the form of an entirely hardware embodiment, an entirely software embodiment (including firmware, resident software, micro-code, etc.) or an embodiment combining software and hardware aspects that may all generally be referred to herein as a “circuit,” “module” or “system.” The present invention may take the form of a computer program product embodied in one or more computer readable medium(s) having computer readable program code embodied thereon.

One or more computer readable medium(s) may be utilized, alone or in combination. A suitable computer readable storage medium may be, for example, but not limited to, an electronic, magnetic, optical, electromagnetic, infrared, or semiconductor system, apparatus, or device, or any suitable combination of the foregoing. Other examples of suitable computer readable storage medium would include, without limitation, the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. A suitable computer readable storage medium may be any tangible medium that can contain, or store the program and images for use by or in connection with an instruction execution system, apparatus, or device.

Program code embodied on a computer readable medium may be transmitted using any appropriate medium, including but not limited to wireless, wireline, optical fiber cable, radio frequency (RF) or the like, or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to diagrams of function blocks or modules in drawing FIGS. 10A and 10B showing methods, apparatus (systems) and computer program products according to embodiments of the invention. It will be understood that each block and combinations of blocks in the drawings can be implemented by computer program instructions. These computer program instructions may be provided to a processor of a general purpose computer, special purpose computer, or other programmable data processing apparatus such as the handheld device shown in FIG. 11 to produce a machine, such that the instructions, which execute via the processor of the computer or other programmable data processing apparatus, create means for implementing the functions/acts specified in the function blocks or modules in drawing FIGS. 10A and 10B.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the function blocks or modules in drawing FIGS. 10A and 10B.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the function blocks or modules in drawing FIGS. 10A and 10B.

The function blocks or modules in drawing FIGS. 10A and 10B illustrate the architecture, functionality, and operation of possible implementations of systems, methods and computer program products according to various embodiments of the present invention. In this regard, each block in the drawing may represent a module, segment, or portion of code, which comprises one or more executable instructions for implementing the specified logical function(s). It should also be noted that, in some alternative implementations, the functions noted in the block may occur out of the order noted in the figures. For example, the function of two blocks shown in succession may, in fact, be executed substantially concurrently, or the blocks may sometimes be executed in the reverse order, depending upon the functionality involved. It will also be noted that each block and combinations of blocks in the drawing can be implemented by special purpose hardware-based systems that perform the specified functions or acts, or combinations of special purpose hardware and computer instructions. Also, although communication between function blocks or modules may be indicated in one direction on the drawing, such communication may also be in both directions.

The crack widths measured may be used to classify the tire sidewall crack and tire in different categories of acceptability. The user may determine a “fail” threshold, for example, a crack having a width w of about 0.3 to 3 mm or more. If no detectable cracks were present in the tire sidewall, it would be rated “good.” If the crack width w were less than 25% of the “fail” threshold, the user would categorize the crack as being “OK” or “acceptable.” If the crack width w were from 25-50% of the “fail” threshold, the crack and tire would be classified as “suspect” and the user may make further investigation of the severity of the crack and its effect on the safety of the tire sidewall. If the crack width w were from 50-75% of the “fail” threshold, the crack and tire would be classified as “monitoring recommended” and the user may further monitor the progression and severity of the crack as the tire is used. If the crack width w were at or above the “fail” threshold, then the crack size would be classified as “reject” and would indicate that the sidewall should be rejected as being unsafe. Other crack widths may be determined to place the crack and tire in these different categories.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A method of measuring a width of a crack in a tire comprising:
capturing an image of at least a portion of said tire;
converting said captured image into a grayscale image;
converting said grayscale image into a binary image;
detecting discrete shapes from said binary image;
bounding each of said discrete shapes by maximum lateral and longitudinal boundary lines to form baseline border shapes encompassing each of said discrete shapes, and selecting a predetermined baseline border shape for further analysis;
for each discrete shape within the baseline border shape, calculating a level of jaggedness for the discrete shape;
measuring the maximum width of said discrete shape for those discrete shapes determined to be sufficiently jagged to be a crack; and
comparing said measured maximum width of said discrete shape to a predetermined margin for unacceptable widths of the crack.

2. The method of claim 1 including:
using a calibration image of known dimension and intensity as a standard to ascertain pixel distance per unit area for said captured image; and
comparing said calibration image to said grayscale image to acquire an intensity threshold for said binary image.

3. The method of claim 2 comprising forming said binary image using said intensity threshold.

4. The method of claim 1 including color inverting said binary image prior to detecting said discrete shapes.

5. The method of claim 1 wherein said baseline border shape comprises a square or rectangle, an ellipse or circle, or other shape tandem combination capable of distinction based upon a calculated distance parameter.

6. The method of claim 1 including measuring the width of said discrete shape, the width measurement comprising:
assigning a measurement baseline within said baseline border shape;
for each pixel of said measurement baseline, calculating a perpendicular distance from said measurement baseline to a first edge of said discrete shape, and to a second edge of said discrete shape; and
obtaining a difference in length between the perpendicular distances calculated at said first discrete shape edge and said second discrete shape edge.

7. The method of claim 1 further including for each discrete shape within the baseline border shape, determining if the discrete shape has a tapered end, and measuring the maximum width of said discrete shape for those discrete shapes determined to be tapered and jagged.

8. The method of claim 7 wherein the said step of determining if each discrete shape in the baseline border shape has a tapered end comprises:
calculating a running average of width measurements for a set of pixels along said measurement baseline;
comparing said running average to individual width measurements for each individual pixel along said measurement baseline;
assigning a label to said discrete shape if said individual width measurements decline in value from said running average of width measurements by a predetermined amount.

9. The method of claim 1 wherein said step of calculating a level of jaggedness for each of said discrete shape comprises:
analytically traversing a contour of an edge line of said discrete shape;
performing a linear interpolation of a segment of pixels defining said contour;
assigning a level of jaggedness based on said linear interpolation.

10. The method of claim 1 wherein said step of comparing said measured maximum width of said discrete shape to a predetermined margin for unacceptable widths includes comparing said maximum width to tire manufacturer specifications or recommendations for acceptable crack widths.

11. The method of claim 8 wherein said predetermined amount includes at least a ten percent reduction in width within said set of pixels.

12. A method of crack detection in a tire sidewall comprising:
capturing an image of at least a portion of said tire sidewall;
converting said image to a grayscale image;
forming a binary image from said grayscale image based upon an intensity threshold;
color inverting said binary image;
employing a shape detection algorithm to identify discrete shapes or blobs within said captured image;
calculating a bounding baseline shape for each discrete shape identified by said shape detection algorithm;
for a predetermined bounding baseline shape, determining if any discrete shape includes a tapered endpoint;
for each discrete shape with at least one tapered endpoint, analyzing said discrete shape for jaggedness, and characterizing said discrete shape as a tire sidewall crack if said discrete shape is bounded by a predetermined baseline shape, has at least one tapered endpoint, and is jagged.

13. The method of claim 12 including:
using a calibration image of known dimension and intensity as a standard to calculate pixel distance per unit length for said captured image; and
comparing said calibration image to said grayscale image to acquire said intensity threshold for said binary image.

14. The method of claim 13 including:
calculating said bounding baseline shape by identifying a first set of pixels of said discrete shape furthest away from one another in a lateral direction and forming a lateral segment having a length based on a distance between said first set of pixels, and identifying a second set of pixels furthest away from one another in a longitudinal direction and forming a longitudinal segment having a length based on a distance between said second set of pixels, the longitudinal segment being perpendicular to the lateral segment; and
determining if said lateral and longitudinal segments form a square or a rectangle based on a ratio of lengths of said longitudinal segment to said lateral segment.

15. The method of claim 14 including using said pixel distance per unit length from said calibration to calculate said lateral and longitudinal lengths.

16. The method of claim 12 including:
ensuring that at least one endpoint of said discrete shape is within the captured image;
performing multiple width calculations for a set of pixels outlining each edge of said discrete shape near said endpoint, for each of said at least one endpoint within the captured image; and
determining if said multiple width calculations leading towards said at least one endpoint indicate a continuing decrease in width forming a taper.

17. The method of claim 12 including:
calculating a level of jaggedness for said discrete shape by analytically traversing a contour of an edge line of said discrete shape;
performing a linear interpolation of a segment of pixels defining said contour; and
assigning a level of jaggedness based on said linear interpolation.

18. An apparatus for tire sidewall crack inspection comprising:
a scope providing image magnification and lighting for capturing an image of at least a portion of said tire sidewall;
a microprocessor based system for analyzing said captured image, said microprocessor based system in electrical communication with said scope and tangibly embodying a program of instructions performing the process steps of:
capturing an image of at least a portion of said tire;
converting said captured image into a grayscale image;
converting said grayscale image into a binary image;
detecting discrete shapes from said binary image;
bounding each of said discrete shapes by maximum lateral and longitudinal boundary lines to form baseline border shapes encompassing each of said discrete shapes, and selecting a predetermined baseline border shape for further analysis;
for each discrete shape within the baseline border shape, calculating a level of jaggedness for the discrete shape;
measuring the maximum width of said discrete shape for those discrete shapes determined to be sufficiently jagged to be a crack; and
comparing said measured maximum width of said discrete shape to a predetermined margin for unacceptable widths of the crack.

19. The apparatus of claim 18 wherein the program of instructions of said microprocessor based system further performs the process steps of, for each discrete shape within the baseline border shape, determining if the discrete shape has a tapered end, and measuring the maximum width of said discrete shape for those discrete shapes determined to be tapered and jagged.

20. The apparatus of claim 18 wherein said scope includes a tire mating end having activation switches electrically connected in series to initiate image capture when said switches are simultaneously activated.

21. The apparatus of claim 18 wherein said lighting includes at least one light emitting diode, a laser diode, or an incandescent light source within said scope or connected to said scope by optical waveguide.

22. A method of determining crack condition on a sidewall of a tire comprising:
capturing an image of at least a portion of a sidewall of said tire;
converting said captured image into a grayscale image;
converting said grayscale image into a binary image;
detecting discrete shapes from said binary image;
selecting a discrete shape from said binary image;
determining if the selected discrete shape is a tire sidewall crack;
if the selected discrete shape is determined to be a tire sidewall crack, measuring maximum width of the selected discrete shape;
comparing the measured maximum width of the tire sidewall crack to a predetermined margin for unacceptable widths; and
determining the tire sidewall crack condition based on the degree of crack width.

23. The method of claim 22 wherein the largest visible crack on the tire sidewall tire is used to determine the sidewall crack condition.

24. The method of claim 22 wherein the sidewall crack condition is determined by placing the tire sidewall crack in a category of acceptability selected from different categories of acceptability.
